(19) United States
(12) Patent Application Publication
(10) Pub. No.: US 2018/0319008 A1
(43) Pub. Date: Nov. 8, 2018

(54) Self Lifting Automotive Engine Stand

(71) Applicant: David Alan Cook, Griffin, GA (US)

(72) Inventor: David Alan Cook, Griffin, GA (US)

(73) Assignee: David Alan Cook, Griffin, GA (US)

(21) Appl. No.: 15/998,130

(22) Filed: Jul. 7, 2018

(51) Int. Cl. B25H 5/00; B66C 23/48

(52) U.S. Cl. CPC B25H 5/00; B66C 23/485

(57) ABSTRACT

An auxiliary powered self lifting engine stand consisting of a portable frame having one rear cross member with two forward members capable of folding up for easy storage. Also a boom for lifting engine with a sleeve for housing a tube with engine clamp with rotating capability further having two leveling arms to maintain correct angle while lifting load into place with a mechanical lock to secure work while in use and a hydraulic cylinder mounted on lower end to front cross member to lift load powered by an air over hydraulic pump resting in a carry tray. Castors are used to maneuver machine into place.

### BACKGROUND OF INVENTION

The present invention relates to the field of engine stands and more particularly to the noval stand having powered means of lifting engine from floor to work height without an auxiliary source, also having castors to move stand to desired work place. Engine stands of the past required engines to be lifted by external means and placed on work stands to provide access to different angles of engine for repair. Automotive engines being heavy would generally require two or more people to lift or special lifting equipment such as engine hoists or cranes. While this works it is time consuming and takes up too much floor space as most engines require mounting and dismounting several times during a rebuild process. There are attempts made at self lifting stands. However, they have cranes attached to a platform making them large and heavy. This way still requires lifting and trying to ring the hole and sometimes still requires two people.

### BRIEF SUMMARY OF INVENTION

The present invention eliminates some of the pre-existing problems by allowing the means of lifting engine by decent of main post to a level excepting engine hookup the lifting engine to the locked position for work. This is done with the frame work consisting of a rear cross member, a front cross member, two side members with castors on all four corners allowing movement of machine upon which two adjustable lifting arms are attached on a fulcrum consisting of four brackets with a collector head on the other end and two leveling arms mounted on the same brackets and head to provide proper angle throughout the stroke. A hydraulic cylinder between the masts provides lifting action and a mechanical lock provide safety and stability at the top of the stroke. An air over hydraulic pump pushes cylinder out under pressure and gravity retracts it on the down stroke when port is open to reservoir. The legs fold up for storage and a wheel in front of the front cross member prevent it from toppling when in storage.

### BRIEF DESCRIPTION OF DRAWINGS

FIG. 1 Illustrates position of machine fully raised at 45 degree angle from right rear

FIG. 2 Illustrates position of machine fully raised at 20 degree angle from right front

FIG. 3 Illustrates positon of machine fully raised right profile view

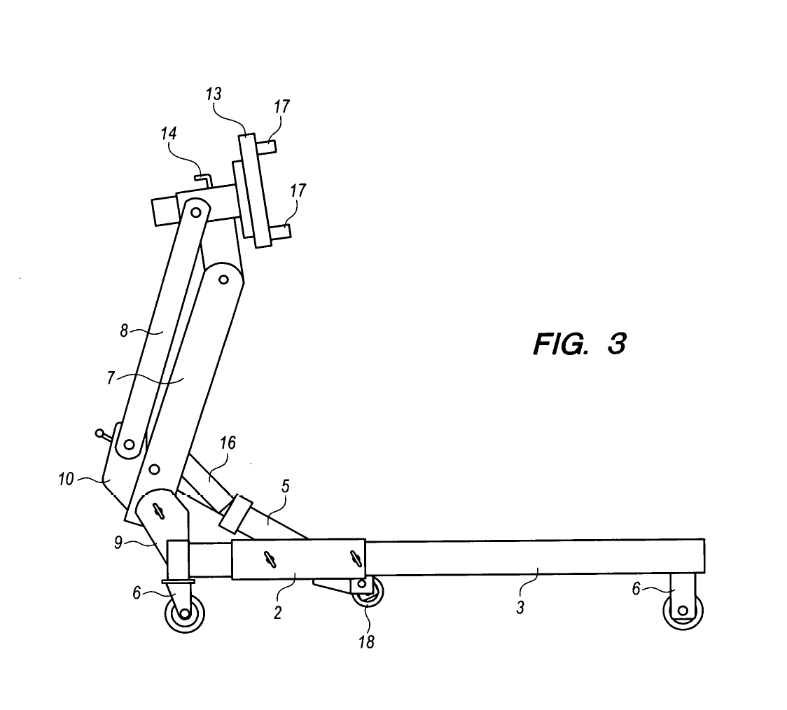

FIG. 4 Illustrates position of machine at 50 degree lift right profile

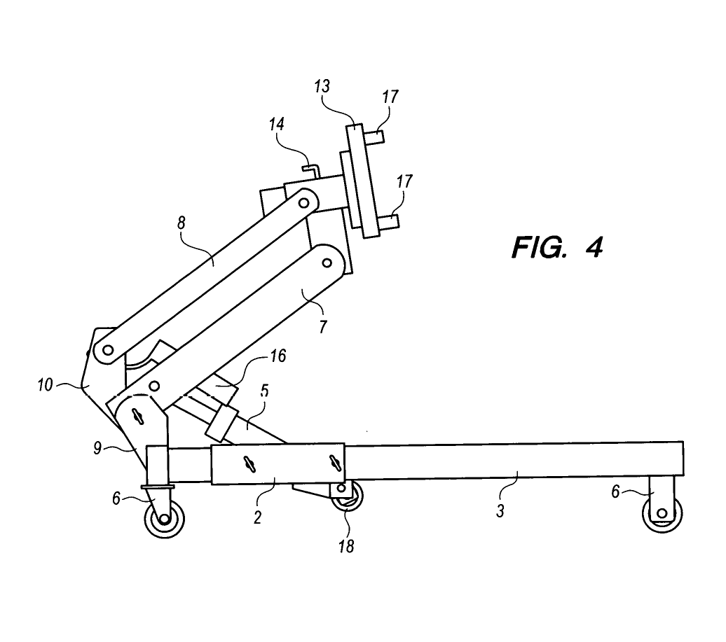

FIG. 5 Illustrates position of machine fully lowered right profile

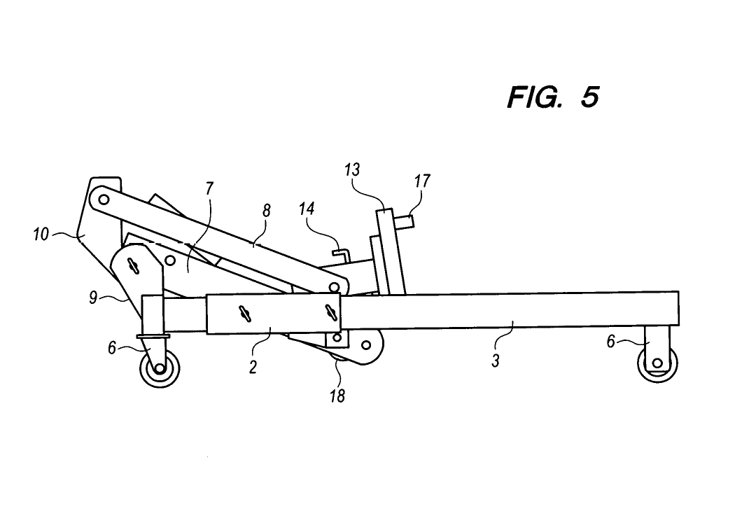

FIG. 6 Illustrates position of machine fully raised right inside center with machine cut in half through center.

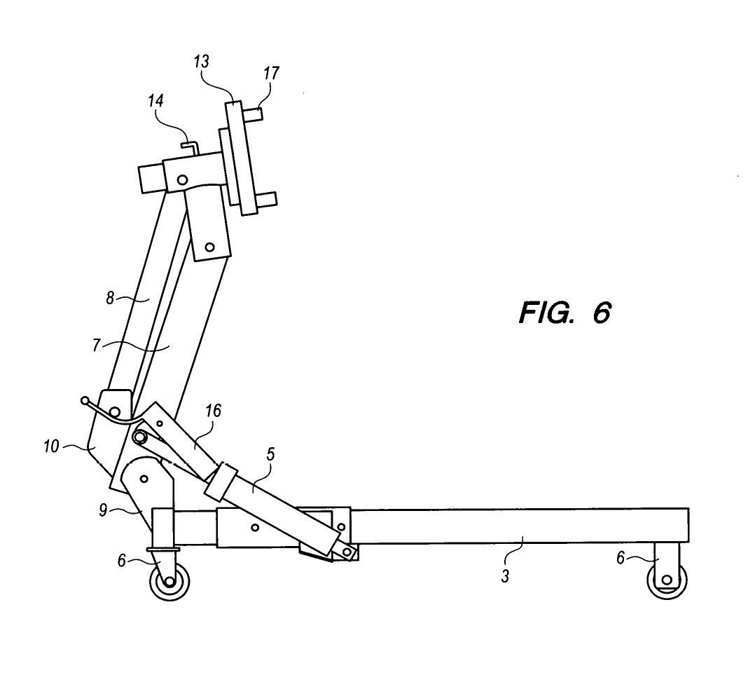

### DETAILED DESCRIPTION OF THE INVENTION

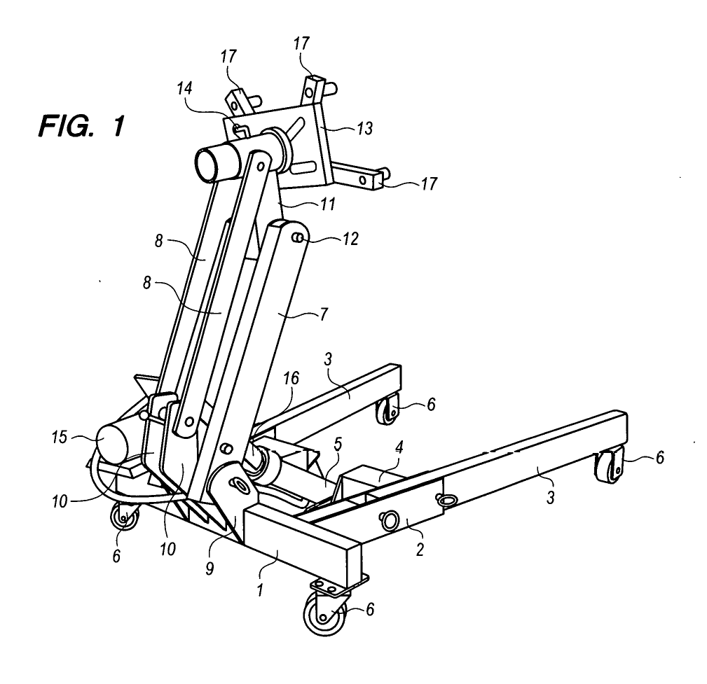

Referring to FIG. 1 the self lifting automotive engine stand of the present invention is illustrated from the right rear angle depicting a lower frame work consisting of a rear cross member 1 connected to two side members 2 at a 10 degree angle with openings for foldable front legs 3 fixed with two clevis pins each to maintain position straight out for use and folded up for storage. A front cross member 4 is fastened to the front inside of each side members with a cutout in the center with two brackets for fastening lower end of hydraulic cylinder 5 lift is able to roll on four castors 6 one at each corner of frame two lifting arms 7 are affixed to four lower brackets with clevis pins, two having one additional hole each to accommodate leveling arms 8. Brackets 9 are connected to rear cross member 1 at and upward rear angle of 45 degrees on the outside of lifting arms 7 with the same holes as bracket 9 and having additional holes for the lower end of leveling arms 8 to provide constant work angle throughout lifting stroke. Upper end of hydraulic cylinder 5 is attached to lifting arms 7 via pins through holes in said lifting arms above brackets 9 and 10 to allow lifting action when cylinder 5 is extended. Top ends of lifting arms are connected to lower end of a collector head 11 with one through bolt 12 in an elongated hole to allow a flexible hook up to a mounting plate 13 leveling arms 8 are mounted to top of collector head 11 by two bolts and locknut's made onto top sides of said collector head in proper location to provide correct work angel of said collector head. A horizontal tube fastened to top of collector head allows penetration of smaller tube on rear of mounting plate 13 from the front of the collector head to allow rotating action of mounting plate 13 holes are drilled throughout the circumference of said mounting plate tube to provide stops at different degrees of rotation by dropping a locking pin 14 in holes through a single hole in top of the collector head. An air over hydraulic pump 15 supplies fluid pressure to hydraulic cylinder 5 to raise unit to the working height and locking on mechanical lock 16 unit is lower by raising slightly, releasing mechanical lock and releasing fluid pressure allowing fluid to return to the reservoir in pump. Engine to be repaired is mounted on unit with four engine brackets 17 mounted onto slotted holes in mounting plate 13.

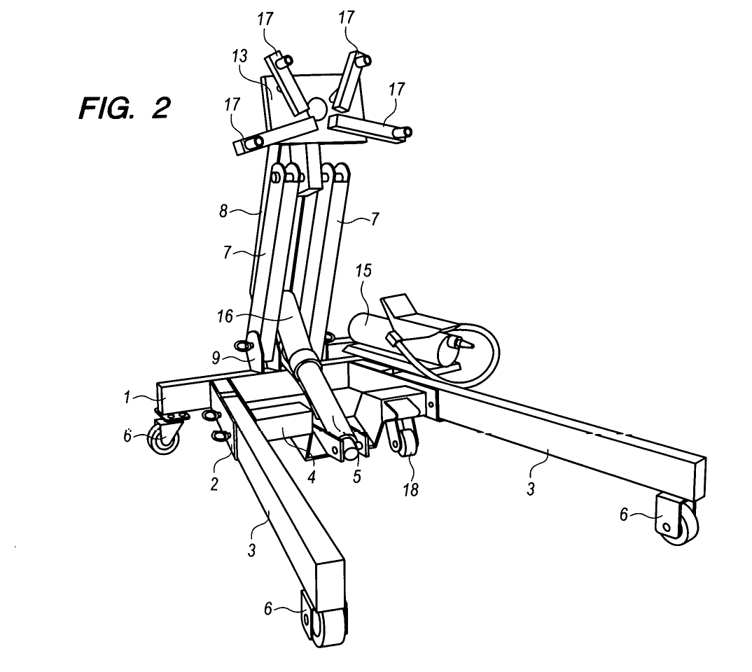

Referring now to FIG. 2 air over hydraulic pump 15 can also be replaced with an electric pump of ac or dc current or a manual hydraulic pump. If no power or compressed air is available unit may also be raised manually to lock position and used as a regular engine stand. A fifth wheel 18 is attached to the left front side of cross member 4 to provide stability when front legs 3 are folded up for storage. A mechanical lock pivots at the top of hydraulic cylinder 5 and gravity places it in lock position when cylinder is extended. It is pulled away by handle on rear and allows retracting of cylinder to lower unit. Unmentioned mechanical fasteners throughout unit may consist of a variety such as clevis pins, hex head cap screws with nuts or socket head cap screws with nuts.

The claimed invention is:

1. A self lifting automotive engine stand comprising of a power lifting capability wherein correct working angle of engine is maintained throughout lifting stroke.

2. Further claimed is a self lifting automotive engine stand of claim 1 wherein unit is equipped with a mechanical safety lock at the top of the stroke.

3. Further claimed is a self lifting automotive engine stand of claim 3 wherein unit may also be lifted to lock position manually.
